(19) United States
(12) Patent Application Publication
(10) Pub. No.: US 2026/0179838 A1
(43) Pub. Date: Jun. 25, 2026

(54) MULTILAYER CERAMIC CAPACITOR

(71) Applicant: Murata Manufacturing Co., Ltd., Nagaokakyo-shi (JP)

(72) Inventors: Shoji FUKUI, Nagaokakyo-shi (JP); Kyosuke INOUE, Nagaokakyo-shi (JP); Akito MORI, Nagaokakyo-shi (JP)

(73) Assignee: Murata Manufacturing Co., Ltd., Nagaokakyo-shi (JP)

(21) Appl. No.: 19/541,423

(22) Filed: Feb. 17, 2026

Related U.S. Application Data
(63) Continuation of application No. PCT/JP2024/027643, filed on Aug. 2, 2024.

(30) Foreign Application Priority Data
Nov. 22, 2023 (JP) 2023-198281

(51) Int. Cl. H01G 4/12; H01G 4/012; H01G 4/232; H01G 4/248; H01G 4/30

(52) U.S. Cl. CPC H01G 4/12; H01G 4/012; H01G 4/1218; H01G 4/1227; H01G 4/232; H01G 4/248; H01G 4/30

(57) ABSTRACT

A capacitor includes an element body portion having a plurality of dielectric layers, internal electrode layers and a coating layer containing Si. A first minimum thickness of the coating layer first and second side surfaces is larger than a second minimum thickness of the coating layer located between a plurality of dielectric layers and an external electrode at the first and second end surfaces.

### CROSS-REFERENCE TO RELATED APPLICATIONS

The present application is a Continuation of PCT Application No. PCT/JP2024/027643, filed on Aug. 2, 2024, which claims priority to Japanese Patent Application No. 2023-198281, filed Nov. 22, 2023, the entire contents of each of which are incorporated herein by reference.

### TECHNICAL FIELD

The present disclosure relates to a multilayer ceramic capacitor.

### BACKGROUND ART

Japanese Patent Laid-Open No. 2022-116342 (PTL 1) is a prior art document that discloses a configuration of a multilayer capacitor. The multilayer capacitor described in PTL 1 includes a capacitor body and an amorphous dielectric film formed on a main surface and a side surface of the capacitor body, the amorphous dielectric film being in direct contact with an internal electrode. The amorphous dielectric film formed on an end surface is removed by etching or sandblasting.

### CITATION LIST

### Patent Literature

PTL 1: Japanese Patent Laid-Open No. 2022-116342

### SUMMARY

### Technical Problems

In removal of the amorphous dielectric film formed on the end surface by etching or sandblasting, a part of the amorphous dielectric film on the main surface and the side surface is also removed together, and moisture resistance of a multilayer ceramic capacitor lowers.

The present disclosure was made in view of a problem above, and an object thereof is to provide a multilayer ceramic capacitor that can achieve suppression of lowering in moisture resistance.

### Solutions to Problems

A multilayer ceramic capacitor based on the present disclosure includes an element body portion and an external electrode. The element body portion includes a plurality of dielectric layers and a plurality of internal electrode layers that are layered in a layering direction, and it is provided with a first main surface and a second main surface opposed to each other in the layering direction, a first side surface and a second side surface opposed to each other in a width direction orthogonal to the layering direction, and a first end surface and a second end surface opposed to each other in a length direction orthogonal to the layering direction and the width direction. The external electrode is provided on each of the first end surface and the second end surface, and electrically connected to the plurality of internal electrode layers. The element body portion is provided with a coating layer containing Si. A minimum thickness of the coating layer located on ends of the plurality of internal electrode layers in the width direction is larger than a minimum thickness of the coating layer located between the plurality of dielectric layers and the external electrode.

### Advantageous Effects

According to the present disclosure, lowering in moisture resistance of a multilayer ceramic capacitor can be suppressed.

### BRIEF DESCRIPTION OF DRAWINGS

FIG. 1 is a perspective view schematically showing an appearance of a multilayer ceramic capacitor according to an embodiment.

FIG. 2 is a perspective view schematically showing an element body portion of the multilayer ceramic capacitor according to the embodiment.

FIG. 3 is a schematic cross-sectional view of the multilayer ceramic capacitor shown in FIG. 1 when viewed from a direction along the line III-III.

FIG. 4 is a schematic cross-sectional view of the multilayer ceramic capacitor shown in FIG. 1 when viewed from a direction along the line IV-IV.

FIG. 5 is a schematic cross-sectional view of the multilayer ceramic capacitor shown in FIG. 3 when viewed from a direction along the line V-V.

FIG. 6 is a schematic cross-sectional view of the multilayer ceramic capacitor shown in FIG. 3 when viewed from a direction along the line VI-VI.

FIG. 7 is a schematic cross-sectional view for illustrating details of a side margin portion of the multilayer ceramic capacitor according to the embodiment.

FIG. 8 is a schematic cross-sectional view for illustrating details of an outer layer portion of the multilayer ceramic capacitor according to the embodiment.

FIG. 9 is a schematic cross-sectional view for illustrating details of an end margin portion and an external electrode of the multilayer ceramic capacitor according to the embodiment.

FIG. 10 is a schematic cross-sectional view showing a detailed configuration of the external electrode of the multilayer ceramic capacitor according to the embodiment.

FIG. 11 is a schematic cross-sectional view for illustrating displacement in a width direction of an extension portion of an internal electrode layer in the multilayer ceramic capacitor according to the embodiment.

FIG. 12 is a flowchart showing a method of manufacturing a multilayer ceramic capacitor according to the embodiment.

FIG. 13 is a schematic cross-sectional view for illustrating details of the end margin portion and the external electrode of a multilayer ceramic capacitor according to a modification.

FIG. 14 is a flowchart showing a method of manufacturing a multilayer ceramic capacitor according to the modification.

### DESCRIPTION OF EMBODIMENTS

An embodiment of the present disclosure will be described in detail below with reference to the drawings. In the embodiment shown below, the same or common elements have the same reference characters allotted in the drawings and description thereof will not be repeated. In the drawings, a length direction of an element body portion which will be described later is denoted as L, a width direction of the element body portion is denoted as W, and a layering direction of the element body portion is denoted as T.

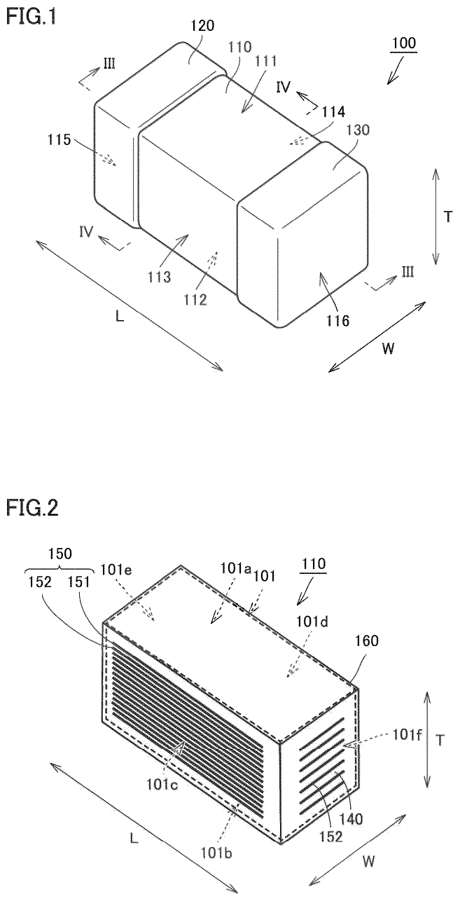

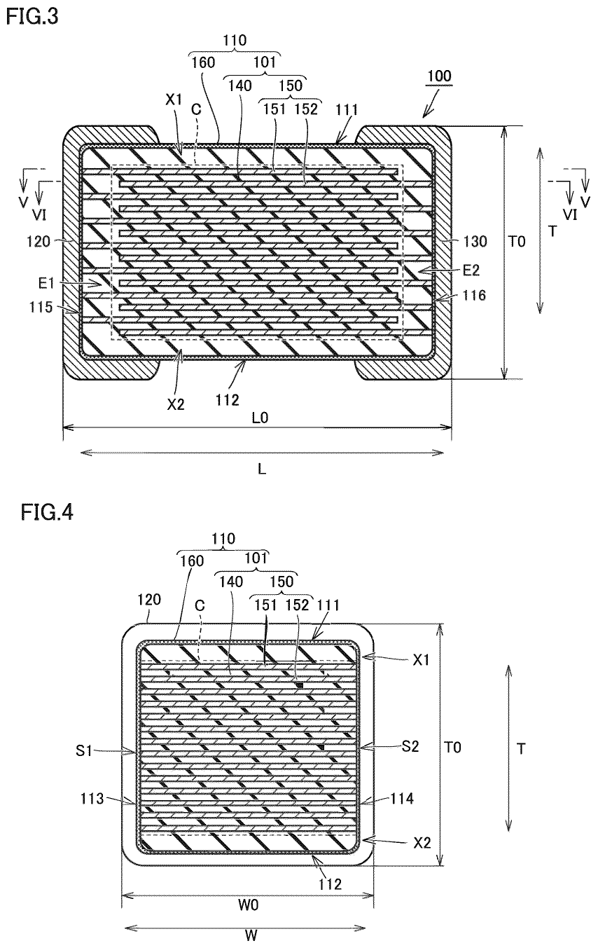

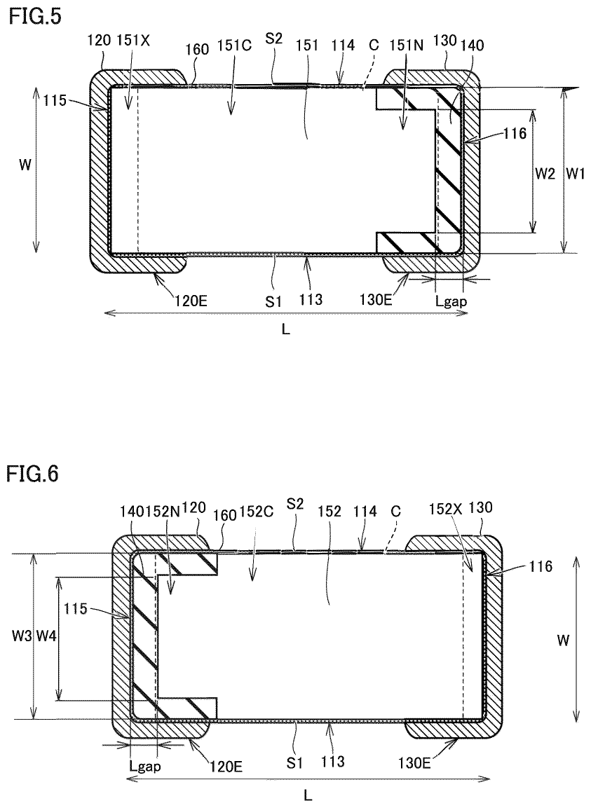

FIG. 1 is a perspective view schematically showing an appearance of a multilayer ceramic capacitor according to an embodiment. FIG. 2 is a perspective view schematically showing the element body portion of the multilayer ceramic capacitor according to the embodiment. FIG. 3 is a schematic cross-sectional view of the multilayer ceramic capacitor shown in FIG. 1 when viewed from a direction along the line III-III. FIG. 4 is a schematic cross-sectional view of the multilayer ceramic capacitor shown in FIG. 1 when viewed from a direction along the line IV-IV. FIG. 5 is a schematic cross-sectional view of the multilayer ceramic capacitor shown in FIG. 3 when viewed from a direction along the line V-V. FIG. 6 is a schematic cross-sectional view of the multilayer ceramic capacitor shown in FIG. 3 when viewed from a direction along the line VI-VI.

As shown in FIGS. 1 to 6, a multilayer ceramic capacitor 100 according to the embodiment includes an element body portion 110 and an external electrode. Multilayer ceramic capacitor 100 includes a first external electrode 120 and a second external electrode 130 as the external electrode.

As shown in FIG. 1, element body portion 110 is substantially in a shape of a parallelepiped. Element body portion 110 is provided with a first main surface 111 and a second main surface 112 opposed to each other in layering direction T, a first side surface 113 and a second side surface 114 opposed to each other in width direction W orthogonal to layering direction T, and a first end surface 115 and a second end surface 116 opposed to each other in length direction L orthogonal to layering direction T and width direction W.

Element body portion 110 may have a corner portion and a ridgeline portion rounded. The corner portion is a portion where three surfaces of element body portion 110 meet one another and the ridgeline portion is a portion where two surfaces of element body portion 110 meet each other.

As shown in FIGS. 1 and 3 to 6, first external electrode 120 is provided at first end surface 115. Specifically, first external electrode 120 is formed over the entire first end surface 115 and formed to extend from first end surface 115 to reach first main surface 111, second main surface 112, first side surface 113, and second side surface 114. As shown in FIGS. 5 and 6, first external electrode 120 includes a first extension portion 120E that extends from first end surface 115 to each of first side surface 113 and second side surface 114.

As shown in FIGS. 1 and 3 to 6, second external electrode 130 is provided at second end surface 116. Specifically, second external electrode 130 is formed over the entire second end surface 116 and formed to extend from second end surface 116 to reach first main surface 111, second main surface 112, first side surface 113, and second side surface 114. As shown in FIGS. 5 and 6, second external electrode 130 includes a second extension portion 130E that extends from second end surface 116 to each of first side surface 113 and second side surface 114.

A detailed configuration of first external electrode 120 and second external electrode 130 will be described later.

As shown in FIGS. 2 to 6, element body portion 110 includes a multilayer body 101 and a coating layer 160. Coating layer 160 contains Si and K.

Multilayer body 101 is provided with a pair of main surfaces 101a and 101b opposed to each other in layering direction T, a pair of side surfaces 101c and 101d opposed to each other in the width direction, and a pair of end surfaces 101e and 101f opposed to each other in the length direction. The pair of main surfaces 101a and 101b, the pair of side surfaces 101c and 101d, and the pair of end surfaces 101e and 101f are covered with coating layer 160. Coating layer 160 is located at first side surface 113, second side surface 114, first main surface 111, and second main surface 112. A plurality of dielectric layers 140 are covered with coating layer 160 at first end surface 115 and second end surface 116. A multilayer ceramic capacitor based on the present disclosure includes an element body portion 110 and an external electrode 120, 130 on the end surfaces of the element body portion 110 to provide for electrical connection.

As shown in FIGS. 2 to 4, multilayer body 101 includes a plurality of dielectric layers 140 and a plurality of internal electrode layers 150 that are alternately layered along layering direction T.

The plurality of internal electrode layers 150 include a plurality of first internal electrode layers 151 and a plurality of second internal electrode layers 152. The plurality of first internal electrode layers 151 and the plurality of second internal electrode layers 152 are alternately layered in layering direction T.

The plurality of first internal electrode layers 151 are drawn to end surface 101e. The plurality of first internal electrode layers 151 are electrically connected to first external electrode 120. The plurality of second internal electrode layers 152 are drawn to end surface 101f. The plurality of second internal electrode layers 152 are electrically connected to second external electrode 130. Opposing ends in width direction W of the plurality of first internal electrode layers 151 and the plurality of second internal electrode layers 152 are exposed at side surfaces 101c and 101d.

Though FIGS. 2 to 4 show an example where a plurality of pairs, e.g., seven, of first internal electrode layers 151 and second internal electrode layers 152 are provided, the number of pairs are not limited to seven. The number of internal electrode layers 150 may be not smaller than one and not larger than one thousand. Internal electrode layer 150 may have a thickness not smaller than 0.3 μm and not larger than 0.8 μm.

As shown in FIG. 5, first internal electrode layer 151 includes a first opposed portion 151C and a first drawn portion 151X. First opposed portion 151C is opposed to second internal electrode layer 152 adjacent in layering direction T. First drawn portion 151X connects first opposed portion 151C and first external electrode 120 to each other. First drawn portion 151X is drawn toward first end surface 115. First opposed portion 151C and first drawn portion 151X are integrally formed.

First internal electrode layer 151 is provided with a first narrow-width portion 151N narrower in width in width direction W than a central portion in length direction L, on a side opposite to a side where it is connected to first external electrode 120 in length direction L. In width direction W, a width W2 of first narrow-width portion 151N is narrower than a width W1 of first opposed portion 151C.

As shown in FIG. 5, a region where adjacent internal electrode layers 150 in element body portion 110 on a side of second end surface 116 are not superimposed on each other in layering direction T, that is, a region from an end on the side of second end surface 116 of a region where internal electrode layers 150 adjacent to each other are superposed on each other in layering direction T to second end surface 116, is defined as Lgap.

First narrow-width portion 151N does not necessarily have to be formed, and a portion where first narrow-width portion 151N is formed may have width W1. In this case, a length in length direction L of extension portion 120E of first external electrode 120 may be shorter than a length of Lgap along length direction L or the first extension portion 120E is not formed.

As shown in FIG. 6, second internal electrode layer 152 includes a second opposed portion 152C and a second drawn portion 152X. Second opposed portion 152C is opposed to first internal electrode layer 151 adjacent in layering direction T. Second drawn portion 152X connects second opposed portion 152C and second external electrode 130 to each other. Second drawn portion 152X is drawn toward second end surface 116. Second opposed portion 152C and second drawn portion 152X are integrally formed.

Second internal electrode layer 152 is provided with a second narrow-width portion 152N narrower in width in width direction W than a central portion in length direction L, on a side opposite to a side where it is connected to second external electrode 130 in length direction L. In width direction W, a width W4 of second narrow-width portion 152N is narrower than a width W3 of second opposed portion 152C.

As shown in FIG. 6, a region where adjacent internal electrode layers 150 in element body portion 110 on a side of first end surface 115 are not superimposed on each other in layering direction T, that is, a region from an end on the side of first end surface 115 of the region where internal electrode layers 150 adjacent to each other are superimposed on each other in layering direction T to first end surface 115, is defined as Lgap.

Second narrow-width portion 152N does not necessarily have to be formed, and a portion where second narrow-width portion 152N is formed may have width W3. In this case, a length in length direction L of the second extension portion 130E of second external electrode 130 may be shorter than a length of Lgap along length direction L or the second extension portion 130E is not formed.

Each of first internal electrode layer 151 and second internal electrode layer 152 contains one type of metal selected from the group consisting of Ni, Cu, Ag, Pd, and Au or an alloy containing the metal. In the present embodiment, each of first internal electrode layer 151 and second internal electrode layer 152 contains Ni as a main component. Each of first internal electrode layer 151 and second internal electrode layer 152 may further contain dielectric particles based on the same composition as ceramic contained in dielectric layer 140. Each of first internal electrode layer 151 and second internal electrode layer 152 may contain Sn at an interface with dielectric layer 140.

The plurality of dielectric layers 140 are formed from an outer dielectric layer located between internal electrode layer 150 located closest to first main surface 111 in layering direction T and first main surface 111 and an outer dielectric layer located between internal electrode layer 150 located closest to second main surface 112 in layering direction T and second main surface 112 as well as an inner dielectric layer located between internal electrode layers 150 adjacent in layering direction T. The number of dielectric layers 140 may be not smaller than one hundred and larger than one thousand. Dielectric layer 140 may have a thickness not smaller than 0.4 μm and not larger than 0.8 μm.

Dielectric ceramic containing, for example, such a component as BaTiO₃, CaTiO₃, SrTiO₃, or CaZrO₃ can be employed as a ceramic material for the plurality of dielectric layers 140. A material obtained by addition of a sub component such as an Mn compound, an Fe compound, a Cr compound, a Co compound, or an Ni compound to these main components may be employed.

As shown in FIGS. 3 and 4, element body portion 110 is partitioned into an inner layer portion C, a first outer layer portion X1 and a second outer layer portion X2, a first side margin portion S1 and a second side margin portion S2, and a first end margin portion E1 and a second end margin portion E2. Inner layer portion C has a capacitance by layering of later-described first opposed portion 151C of first internal electrode layer 151 and later-described second opposed portion 152C of second internal electrode layer 152 in layering direction T.

First outer layer portion X1 and second outer layer portion X2 sandwich inner layer portion C therebetween in layering direction T. First outer layer portion X1 is located outside inner layer portion C in layering direction T and located on a side of first main surface 111. In other words, first outer layer portion X1 is located closer to first main surface 111 relative to internal electrode layer 150 located closest to first main surface 111 in layering direction T. Second outer layer portion X2 is located outside inner layer portion C in layering direction T and located on a side of second main surface 112. In other words, second outer layer portion X2 is located closer to second main surface 112 relative to internal electrode layer 150 located closest to second main surface 112 in layering direction T.

Each of first outer layer portion X1 and second outer layer portion X2 extends in length direction L and width direction W so as to include the ridgeline portion of element body portion 110. Each of first outer layer portion X1 and second outer layer portion X2 may have a thickness not smaller than 10 μm and not larger than 30 μm.

Each of first outer layer portion X1 and second outer layer portion X2 includes an outermost layer portion arranged outermost and an inner-side outer layer portion located inside this outermost layer portion. The outermost layer portion is formed from coating layer 160. The inner-side outer layer portion is formed from the outer dielectric layer.

As shown in FIG. 3, first end margin portion E1 and second end margin portion E2 sandwich inner layer portion C therebetween in length direction L. First end margin portion E1 is located outside inner layer portion C in length direction L and located on the side of first end surface 115. Second end margin portion E2 is located outside inner layer portion C in length direction L and located on the side of second end surface 116.

As shown in FIGS. 4 to 6, in element body portion 110, the side margin portion is located between first side surface 113 and the plurality of internal electrode layers 150 and between second side surface 114 and the plurality of internal electrode layers 150 in width direction W. The side margin portion is formed from coating layer 160. Coating layer 160 covers opposing ends of the plurality of internal electrode layers 150 in width direction W.

Specifically, first side margin portion S1 is provided at side surface 101c of the multilayer body. First side margin portion S1 is provided to cover the entire side surface 101c. First side margin portion S1 is present from one end of internal electrode layer 150 located on one side in width direction W to first side surface 113 in element body portion 110. In other words, coating layer 160 is formed at one end in width direction W and at the central portion in length direction L of each of the plurality of internal electrode layers 150.

Second side margin portion S2 is provided at side surface 101d of the multilayer body. Second side margin portion S2 is provided to cover the entire side surface 101d. Second side margin portion S2 is present from the other end of internal electrode layer 150 located on the other side in width direction W to second side surface 114 in element body portion 110. In other words, coating layer 160 is formed at the other end in width direction W and at the central portion in length direction L of each of the plurality of internal electrode layers 150.

A size of multilayer ceramic capacitor 100 including element body portion 110, first external electrode 120, and second external electrode 130 is not particularly limited, and for example, a range below may be adopted.

As shown in FIG. 3, a dimension in length direction L (a length dimension L0) of multilayer ceramic capacitor 100 is, for example, not smaller than 0.1 mm and not larger than 3.2 mm. A dimension in layering direction T (a thickness dimension T0) of multilayer ceramic capacitor 100 is not smaller than 0.05 mm and not larger than 1.6 mm. As shown in FIG. 4, a dimension in width direction W (a width dimension W0) of multilayer ceramic capacitor 100 is, for example, not smaller than 0.05 mm and not larger than 1.6 mm.

Multilayer ceramic capacitor 100 has, for example, a size of length dimension L0 of 0.1 mm, width dimension W0 of 0.05 mm, and thickness dimension T0 of 0.05 mm, a size of length dimension L0 of 0.6 mm, width dimension W0 of 0.3 mm, and thickness dimension T0 of 0.3 mm, a size of length dimension L0 of 1.0 mm, width dimension W0 of 0.5 mm, and thickness dimension T0 of 0.5 mm, a size of length dimension L0 of 1.6 mm, width dimension W0 of 0.8 mm, and thickness dimension T0 of 0.8 mm, or a size of length dimension L0 of 3.2 mm, width dimension W0 of 1.6 mm, and thickness dimension T0 of 1.6 mm. A tolerance is added to the size above.

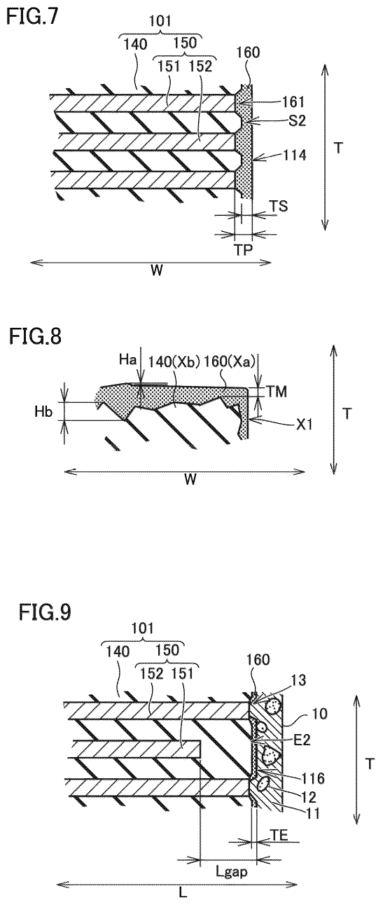

FIG. 7 is a schematic cross-sectional view for illustrating details of the side margin portion of the multilayer ceramic capacitor according to the embodiment. FIG. 7 shows a cross-section of element body portion 110 in parallel to layering direction T and width direction W, on a side of second side surface 114. Though a side of second side margin portion S2 will be described in the description below, a side of first side margin portion S1 is also similar.

As shown in FIG. 7, second side margin portion S2 is formed from coating layer 160 containing Si and K. A composition of coating layer 160 can be confirmed by energy dispersive X-ray spectroscopy (EDX). Coating layer 160 is amorphous, and amorphism of coating layer 160 can be confirmed by Raman spectroscopy. Amorphism of coating layer 160 can be confirmed also based on the fact that a specific crystal pattern cannot be detected in X-ray diffraction of coating layer 160.

Second side margin portion S2 projects as being in contact with the ends in width direction W of the plurality of internal electrode layers 150. A part 161 of coating layer 160 in a portion that covers opposing ends of the plurality of internal electrode layers 150 in width direction W thus lies between dielectric layers 140 adjacent in layering direction T among the plurality of dielectric layers 140. The reason for such a shape is that internal electrode layer 150 is higher in ratio of shrinkage than dielectric layer 140 in firing. With this shape of the side margin portion, strength of fixing of the side margin portion to side surfaces 101c and 101d of multilayer body 101 can be increased. Then, separation of the side margin portion can be suppressed.

A minimum thickness TS of coating layer 160 located on the ends of the plurality of internal electrode layers 150 in width direction W may not be smaller than 0.01 μm and larger than 10 μm. From a point of view of moisture resistance, minimum thickness TS may be not smaller than 0.1 μm, e.g., not smaller than 0.3 μm. A shortest distance TP between the plurality of internal electrode layers 150 and first side surface 113 and shortest distance TP between the plurality of internal electrode layers 150 and second side surface 114 are each not shorter than 0.01 μm and not longer than 10 μm. From a point of view of moisture resistance, shortest distance TP may be not shorter than 0.1 μm, e.g., not shorter than 0.3 μm. Numerical ranges of minimum thickness TS and shortest distance TP are not limited as above.

Relation of the shape and the thickness described with reference to FIG. 7 can be confirmed by polishing element body portion 110 from a side of first external electrode 120 to the central portion in length direction L and observing the cross-section of element body portion 110 in parallel to layering direction T and width direction W with an electron microscope or the like. A smallest thickness of coating layer 160 measured in an image picked up by a scanning electron microscope (SEM), of a range where approximately ten first internal electrode layers 151 or approximately ten second internal electrode layers 152 are included in a field of view at the central portion of the cross-section in layering direction T, is defined as minimum thickness TS. Similarly, a shortest distance measured between internal electrode layers 150 and first side surface 113 or second side surface 114 in the image is defined as shortest distance TP.

FIG. 8 is a schematic cross-sectional view for illustrating details of the outer layer portion of the multilayer ceramic capacitor according to the embodiment. FIG. 8 shows the cross-section of element body portion 110 in parallel to layering direction T and width direction W on a side of first outer layer portion X1. Though the side of first outer layer portion X1 will be described in the description below, a side of second outer layer portion X2 is also similar.

As shown in FIG. 8, first outer layer portion X1 includes an outermost layer portion Xa arranged outermost and an inner-side outer layer portion Xb located inside outermost layer portion Xa. Outermost layer portion Xa is formed from coating layer 160. Inner-side outer layer portion Xb is formed from outer dielectric layer 140.

At an outer surface of inner-side outer layer portion Xb, there are fine projections and recesses resulting from dielectric grains in outer dielectric layer 140. Coating layer 160 is amorphous and it covers inner-side outer layer portion Xb to bury projections and recesses at the outer surface of inner-side outer layer portion Xb. Accordingly, there are few projections and recesses at an outer surface of outermost layer portion Xa. Therefore, a maximum height Ha of projections and recesses at the outer surface of outermost layer portion Xa is lower than a maximum height Hb of projections and recesses at the outer surface of inner-side outer layer portion Xb. Impact resistance of outermost layer portion Xa can thus be enhanced and lowering in moisture resistance of multilayer ceramic capacitor 100 can be suppressed.

A minimum thickness TM of coating layer 160 in layering direction T in each of first outer layer portion X1 and second outer layer portion X2 is not smaller than 0.01 μm and not larger than 0.5 μm. A numerical range of minimum thickness TM is not limited as above.

Relation of the shape and the thickness described with reference to FIG. 8 can be confirmed by polishing element body portion 110 from the side of first external electrode 120 to the central portion in length direction L and observing the cross-section of element body portion 110 in parallel to layering direction T and width direction W with an electron microscope or the like. A smallest thickness in layering direction T of coating layer 160 measured in an image picked up by a scanning electron microscope (SEM), of a range where first outer layer portion X1 or second outer layer portion X2 is included in a field of view at an end of the cross-section in layering direction T, is defined as minimum thickness TM.

FIG. 9 is a schematic cross-sectional view for illustrating details of the end margin portion and the external electrode of the multilayer ceramic capacitor according to the embodiment. FIG. 9 shows a cross-section of element body portion 110 in parallel to layering direction T and length direction L on a side of second end margin portion E2. Though the side of second end margin portion E2 will be described in the description below, a side of first end margin portion E1 is also similar.

As shown in FIG. 9, the external electrode includes a Cu layer 10 containing a glass component 12 while it contains a Cu component 11 as a main component. A composition of Cu layer 10 can be confirmed by EDX. Coating layer 160 is arranged at second end surface 116, and a part 13 of Cu layer 10 passes through coating layer 160 and is electrically connected to second internal electrode layers 152. Coating layer 160 is located between the plurality of dielectric layers 140 and the external electrode. Specifically, coating layer 160 is located between the plurality of dielectric layers 140 and Cu layer 10. Cu layer 10 has a thickness not smaller than 30 μm and not larger than 100 μm at the central portion in layering direction T and width direction W. A numerical range of the thickness of Cu layer 10 is not limited as above. Cu layer 10 may be a resin layer containing the Cu component and the glass component. In this case, an underlying metallic layer is formed between the resin layer and coating layer 160.

Minimum thickness TS of coating layer 160 located on the ends of the plurality of internal electrode layers 150 in width direction W shown in FIG. 7 is larger than a minimum thickness TE of coating layer 160 located between the plurality of dielectric layers 140 and Cu layer 10 which is the external electrode shown in FIG. 9.

Relation of the shape and the thickness described with reference to FIG. 9 can be confirmed by polishing element body portion 110 from a side of first side surface 113 to the central portion in width direction W and observing the cross-section of element body portion 110 in parallel to layering direction T and length direction L with an electron microscope or the like. A smallest thickness of coating layer 160 measured in an image picked up by an SEM, of a range where approximately ten first internal electrode layers 151 or approximately ten second internal electrode layers 152 are included in the field of view at the central portion of the cross-section in layering direction T and at the end of the cross-section in length direction L, is defined as minimum thickness TE.

The reason for the shape as shown in FIG. 9 is as below. Coating layer 160 contains K, which makes a melting point of Si contained in coating layer 160 lower than a temperature for firing Cu layer 10. Therefore, coating layer 160 is molten at the time of firing of Cu layer 10, shrinkage force of Cu layer 10 is applied to molten coating layer 160, and part 13 of Cu layer 10 passes through coating layer 160 and is connected to second internal electrode layers 152.

In glass component 12 in Cu layer 10, K contained in coating layer 160 is diffused as being fluidized. In other words, K is contained in glass component 12. A concentration of K contained in glass component 12 is higher as a distance from second end surface 116 is shorter. In addition, some of Si contained in coating layer 160 has been introduced in Cu layer 10 as binding to glass component 12 in Cu layer 10. Cu is diffused from Cu layer 10 into Ni in internal electrode layer 150. Strength of fixing between Cu layer 10 and internal electrode layer 150 thus increases. Then, separation of first external electrode 120 and second external electrode 130 can be suppressed.

A concentration of Si in coating layer 160 located on the ends of the plurality of internal electrode layers 150 in width direction W shown in FIG. 7 is higher than a concentration of Si in coating layer 160 located between the plurality of dielectric layers 140 and the external electrode shown in FIG. 9.

A concentration of K in coating layer 160 located on the ends of the plurality of internal electrode layers 150 in width direction W shown in FIG. 7 is higher than a concentration of K in coating layer 160 located between the plurality of dielectric layers 140 and the external electrode shown in FIG. 9.

A concentration distribution of Si and K may be observed in an image picked up by a transmission electron microscope (TEM) or EDX. For example, a concentration gradient of Si and K is measured with the TEM as a molar ratio to 100 mol of Ti contained in dielectric layer 140 in an image picked up by the TEM, of a range where approximately one first internal electrode layer 151 or approximately one second internal electrode layer 152 is included in the field of view.

According to the configuration of coating layer 160 and the external electrode above, while moisture resistance is secured by the side margin portion small in thickness, electrical connection between internal electrode layers 150 and the external electrode can be secured without removal of coating layer 160 at first end surface 115 and second end surface 116 by sandblasting or the like. In other words, a differential thickness is achieved because the manufacturing process causes the coating layer on the end surfaces to melt and be displaced by the external electrode during firing, while the coating layer on the side surfaces remains substantially intact. This structure provides high moisture resistance at the side surfaces while ensuring excellent electrical connection at the end surfaces without requiring damaging removal steps like sandblasting. Then, a region where internal electrode layers 150 can be arranged can be made larger to achieve reduction in size and a larger capacitance of multilayer ceramic capacitor 100.

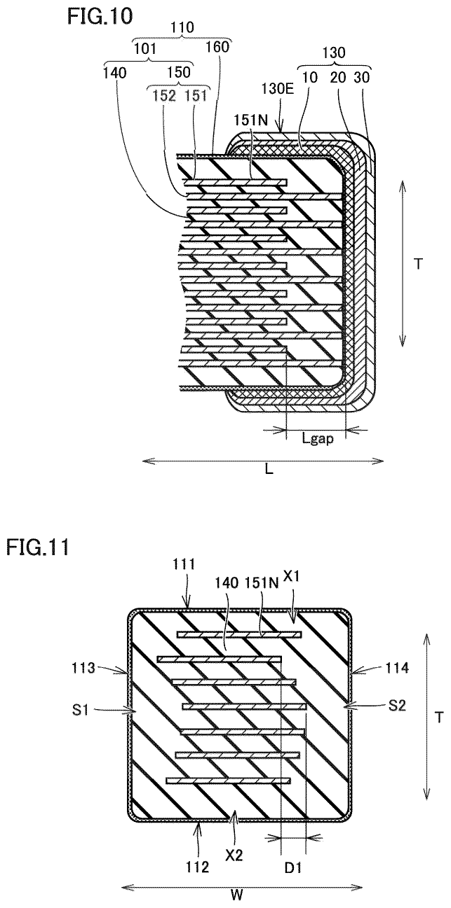

FIG. 10 is a schematic cross-sectional view showing a detailed configuration of the external electrode of the multilayer ceramic capacitor according to the embodiment. FIG. 10 shows the cross-section of element body portion 110 in parallel to layering direction T and length direction L on a side of second external electrode 130. Though the side of second external electrode 130 will be described in the description below, the side of first external electrode 120 is also similar.

As shown in FIG. 10, first external electrode 120 and second external electrode 130 each include Cu layer 10 provided on element body portion 110, an Ni plated layer 20 provided on Cu layer 10, and an Sn plated layer 30 provided on Ni plated layer 20.

A material for the plated layer may be one type of metal selected from the group consisting of Ni, Cu, Ag, Pd, and Au or an alloy containing the metal. A total thickness of Ni plated layer 20 and Sn plated layer 30 is, for example, not smaller than 3 μm and not larger than 20 μm.

In the present embodiment, as shown in FIG. 6, the first extension portion 120E is overlaid only at narrow-width portion 152N, on second internal electrode layer 152 not electrically connected to first external electrode 120 including the first extension portion 120E, among the plurality of internal electrode layers 150 when viewed in width direction W. As shown in FIGS. 5 and 10, the second extension portion 130E is overlaid only at narrow-width portion 151N, on first internal electrode layer 151 not electrically connected to second external electrode 130 including the second extension portion 130E, among the plurality of internal electrode layers 150 when viewed in width direction W.

Electrical connection between the first extension portion 120E and the end in width direction W of second internal electrode layer 152 and resultant short-circuiting therebetween can thus be suppressed. Similarly, electrical connection between the second extension portion 130E and the end in width direction W of first internal electrode layer 151 and resultant short-circuiting therebetween can be suppressed.

FIG. 11 is a schematic cross-sectional view for illustrating displacement in the width direction of the extension portion of the internal electrode layer in the multilayer ceramic capacitor according to the embodiment. A position of the extension portion is not limited to a manner shown in FIG. 11, because it is illustrated in FIG. 11 for the sake of convenience for description of an amount of displacement of the extension portion.

As shown in FIG. 11, an amount of displacement D1 in width direction W between the second extension portion 130E located closest to first side surface 113 among the plurality of second extension portions 130E and the extension portion 130E located closest to second side surface 114 among the plurality of second extension portions 130E is not smaller than 3 μm. An amount of displacement among the plurality of first extension portions 120E is also similar to that among second extension portions 130E. Ends in width direction W of the plurality of extension portions 120E and the plurality of second extension portions 130E are thus not aligned in layering direction T but are displaced in width direction W.

As shown in FIG. 4, on the other hand, in the cross-section of element body portion 110 in parallel to layering direction T and width direction W at the central portion of element body portion 110 in length direction L, an amount of displacement in width direction W of internal electrode layers 150 adjacent in layering direction Tis smaller than 3 μm.

In other words, an amount of position displacement in width direction W of first narrow-width portion 151N and second narrow-width portion 152N is larger than an amount of position displacement in width direction W at the central portion in length direction L of the plurality of internal electrode layers 150.

Therefore, a width of each of first narrow-width portion 151N and second narrow-width portion 152N may be narrower than a width at the central portion in length direction L of the plurality of internal electrode layers 150, by a maximum amount of position displacement assumed in width direction W of first narrow-width portion 151N and second narrow-width portion 152N. Electrical connection between the first extension portion 120E and the end in width direction W of second internal electrode layer 152 and resultant short-circuiting therebetween can thus be suppressed in a stable manner. Similarly, electrical connection between second extension portion 130E and the end in width direction W of first internal electrode layer 151 and resultant short-circuiting therebetween can be suppressed in a stable manner.

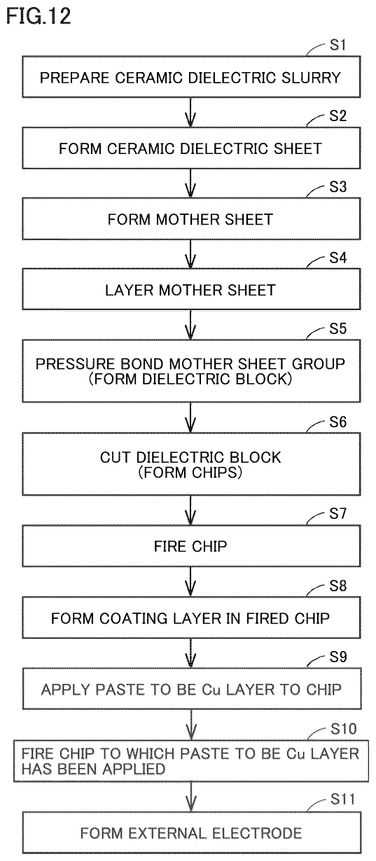

A method of manufacturing multilayer ceramic capacitor 100 according to the present embodiment will be described. FIG. 12 is a flowchart showing the method of manufacturing the multilayer ceramic capacitor according to the embodiment.

As shown in FIG. 12, ceramic dielectric slurry is prepared (step S1). Specifically, ceramic dielectric powders, additive powders, binder resin, a solvent, and the like are mixed as being dispersed to prepare ceramic dielectric slurry. Ceramic dielectric powders are, for example, dielectric particles having a perovskite structure of BaTiO₃, CaTiO₃, SrTiO₃, CaZrO₃, CaHfO₃, or the like. Additive powders are composed, for example, of at least one of an Si compound, an Mg compound, an Mn compound, an Fe compound, a Cr compound, an Ni compound, and a Co compound. Polyurethane resin, urea resin, melamine resin, epoxy resin, vinyl acetate resin, acrylic resin, an aqueous high polymer such as polyvinyl alcohol (PVA) or polyvinyl butyral (PVB), or the like can be adopted as the binder resin. One of them may be used alone or at least two of them may be used as being mixed. Ceramic dielectric slurry may be based on a solvent or water. In an example where ceramic dielectric slurry is a water-based paint, ceramic dielectric slurry is prepared by mixing a water-soluble binder, a dispersant, and the like with a dielectric source material dissolved in water.

A ceramic dielectric sheet is then formed (step S2). Specifically, the ceramic dielectric sheet is formed by forming ceramic dielectric slurry into a sheet on a carrier film with the use of a die coater, a gravure coater, a microgravure coater, or the like and drying the same. From a point of view of reduction in size and a higher capacitance of the multilayer ceramic capacitor, the ceramic dielectric sheet may have a thickness not smaller than 0.4 μm and not larger than 0.8 μm.

A mother sheet is then formed (step S3). Specifically, a conductive paste is applied to the ceramic dielectric sheet in a prescribed pattern so as to form the mother sheet in which a prescribed internal electrode pattern has been provided on the ceramic dielectric sheet. The conductive paste contains Ni powders, a solvent, a dispersant, a binder, and the like, and it is prepared to be constant in viscosity. Polyvinyl butyral (PVB), polyvinyl alcohol (PVA), or the like is employed as the binder. A screen printing method, an ink jet method, a gravure printing method, or the like can be employed as the method of applying the conductive paste. From a point of view of reduction in size and a higher capacitance of the multilayer ceramic capacitor, the internal electrode pattern may have a thickness not smaller than 0.3 μm and not larger than 0.8 μm. A ceramic dielectric sheet not subjected to step S3 is also prepared as the mother sheet, in addition to the mother sheet provided with the internal electrode pattern.

A plurality of mother sheets are then layered (step S4). Specifically, a plurality of mother sheets not provided with the internal electrode pattern and formed only from ceramic dielectric sheets are layered, for example, to a thickness not smaller than 10 μm and not larger than 30 μm. On those mother sheets, a prescribed number of mother sheets provided with the internal electrode pattern are layered. The number of layered mother sheets provided with the internal electrode pattern is, for example, not smaller than one and not larger than one thousand. Further on those mother sheets, a prescribed number of mother sheets not provided with the internal electrode pattern and formed only from ceramic dielectric sheets are layered, for example, to a thickness not smaller than 10 μm and not larger than 30 μm. A mother sheet group is thus formed.

A dielectric block is then formed by pressure bonding of the mother sheet group (step S5). Specifically, the mother sheet group is pressurized and pressure bonded in the layering direction by isostatic pressing or rigid pressing to form the dielectric block. At this time, ceramic dielectric sheets are brought in intimate contact with each other by being pressed at a prescribed temperature. A dielectric sheet provided with the internal electrode pattern can be protected by arrangement of ceramic dielectric sheets corresponding to a certain thickness as the outermost layer in the layering direction and pressing of the same.

The dielectric block is then divided to form chips (step S6). Specifically, the dielectric block is divided in matrix by press cutting, dicing, or laser cutting and singulated to a plurality of chips. In division of the dielectric block, the dielectric block may be divided while it is heated to soften.

The chips are then fired (step S7). Specifically, the chips are heated so that a dielectric material and a conductive material contained in the chips are fired and multilayer body 101 is formed. A temperature for firing is set as appropriate in accordance with the dielectric material and the conductive material.

Coating layer 160 is then formed in the fired chips (step S8). Specifically, fired multilayer body 101 is immersed in a solution containing Si and K and thereafter dried. The solution is, for example, water glass containing K.

A paste to be Cu layer 10 is then applied to the chips (step S9). Specifically, the paste containing the glass component while it contains Cu particles is applied to each of first end surface 115 and second end surface 116 of dried element body portion 110 and dried.

The chips to which the paste to be Cu layer 10 has been applied are then fired (step S10). Specifically, element body portion 110 to which the paste to be Cu layer 10 has been applied is fired at a temperature not lower than 600° C. and not higher than 800° C. A metallic component contained in the paste to be Cu layer 10 is sintered and coating layer 160 is molten, so that first internal electrode layer 151 and Cu layer 10 are electrically connected to each other at first end surface 115 and second internal electrode layer 152 and Cu layer 10 are electrically connected to each other at second end surface 116.

The external electrode is then formed (step S11). Ni plating and Sn plating are applied to Cu layer 10 in this order to form Ni plated layer 20 and Sn plated layer 30, and thus first external electrode 120 and second external electrode 130 are formed.

Through a series of steps described above, multilayer ceramic capacitor 100 according to the embodiment can be manufactured.

A multilayer ceramic capacitor according to a modification of the present embodiment will be described below. The multilayer ceramic capacitor according to the modification is different from multilayer ceramic capacitor 100 according to the present embodiment mainly in that an underlying electrode layer containing Ni as a main component is formed on first end surface 115 and second end surface 116 of element body portion 110, and description of features similar to those in multilayer ceramic capacitor 100 according to the present embodiment will not be repeated.

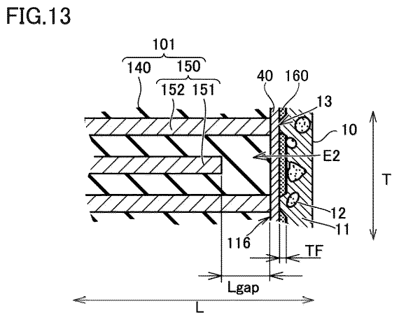

FIG. 13 is a schematic cross-sectional view for illustrating details of the end margin portion and the external electrode of the multilayer ceramic capacitor according to the modification. FIG. 13 shows the cross-section of element body portion 110 in parallel to layering direction T and length direction L on the side of second end margin portion E2. Though the side of second end margin portion E2 will be described in the description below, the side of first end margin portion E1 is also similar.

As shown in FIG. 13, the external electrode includes an underlying electrode layer 40 containing Ni as the main component and Cu layer 10 containing glass component 12 while it contains Cu component 11 as the main component. Underlying electrode layer 40 may further contain dielectric particles based on the same composition as ceramic contained in dielectric layer 140.

Underlying electrode layer 40 is formed on second end surface 116, coating layer 160 is formed on underlying electrode layer 40, and Cu layer 10 is formed on coating layer 160. Underlying electrode layer 40 is covered with Cu layer 10.

Minimum thickness TS of coating layer 160 located on the ends of the plurality of internal electrode layers 150 in width direction W shown in FIG. 7 is larger than a minimum thickness TF of coating layer 160 located between underlying electrode layer 40 and Cu layer 10 shown in FIG. 13.

As shown in FIG. 13, part 13 of Cu layer 10 passes through coating layer 160 and is electrically connected to underlying electrode layer 40. Cu layer 10 is electrically connected to second internal electrode layers 152 through underlying electrode layer 40.

In the present modification, underlying electrode layer 40 is formed to extend from second end surface 116 to reach first main surface 111, second main surface 112, first side surface 113, and second side surface 114. Similarly, underlying electrode layer 40 is formed to extend from first end surface 115 to reach first main surface 111, second main surface 112, first side surface 113, and second side surface 114.

In the multilayer ceramic capacitor according to the modification, Cu layer 10 and second internal electrode layers 152 are electrically connected to each other through underlying electrode layer 40 that covers the entire second end surface 116, and hence second internal electrode layers 152 and second external electrode 130 can electrically be connected to each other in a stable manner. Similarly, Cu layer 10 and first internal electrode layers 151 are electrically connected to each other through underlying electrode layer 40 that covers the entire first end surface 115, and hence first internal electrode layers 151 and first external electrode 120 can electrically be connected to each other in a stable manner.

In glass component 12 in Cu layer 10, K contained in coating layer 160 is diffused as being fluidized. Some of Si contained in coating layer 160 has been introduced in Cu layer 10 as binding to glass component 12 in Cu layer 10. Cu is diffused from Cu layer 10 into Ni in underlying electrode layer 40. Strength of fixing between Cu layer 10 and underlying electrode layer 40 thus increases. Then, separation of first external electrode 120 and second external electrode 130 can be suppressed.

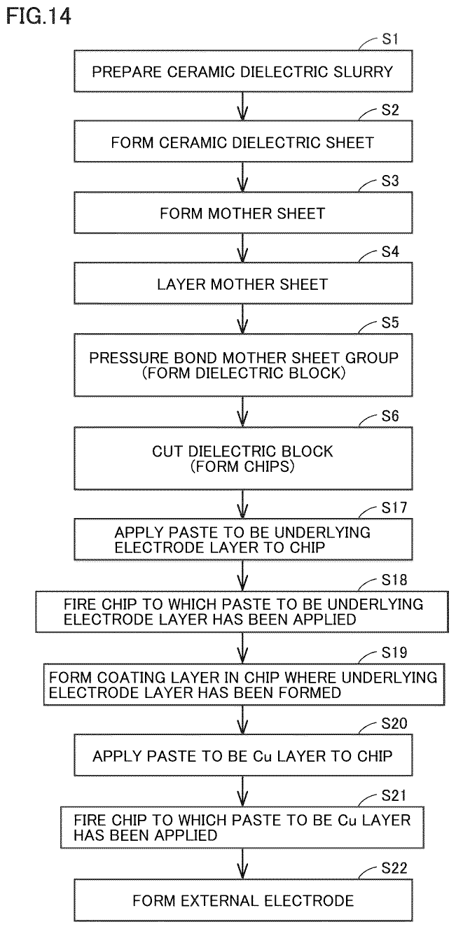

A method of manufacturing the multilayer ceramic capacitor according to the present modification will be described below. FIG. 14 is a flowchart showing the method of manufacturing the multilayer ceramic capacitor according to the modification.

As shown in FIG. 14, step S1 to step S6 in the method of manufacturing the multilayer ceramic capacitor according to the modification are similar to those in the method of manufacturing multilayer ceramic capacitor 100.

After step S6, a paste to be the underlying electrode layer is applied to the chip (step S17). Specifically, a paste containing Ni particles is applied to each of end surface 101e and end surface 101f of multilayer body 101 and dried.

The chip to which the paste to be underlying electrode layer 40 has been applied is then fired (step S18). Specifically, the chip is heated so that the paste containing Ni particles is fired together with the dielectric material and the conductive material contained in the chip and multilayer body 101 and underlying electrode layer 40 are formed.

Coating layer 160 is then formed in the chips provided with underlying electrode layer 40 (step S19). Specifically, multilayer body 101 provided with underlying electrode layer 40 is immersed in a solution containing Si and K and thereafter dried. The solution is, for example, water glass containing K.

A paste to be Cu layer 10 is then applied to the chips (step S20). Specifically, the paste containing the glass component while it contains Cu particles is applied to cover underlying electrode layer 40 on each of first end surface 115 and second end surface 116 with coating layer 160 being interposed and dried.

The chips to which the paste to be Cu layer 10 has been applied are then fired (step S21). Specifically, the chips to which the paste to be Cu layer 10 has been applied are fired at a temperature not lower than 600° C. and not higher than 800° C. A metallic component contained in the paste to be Cu layer 10 is sintered and coating layer 160 is molten, so that underlying electrode layer 40 and Cu layer 10 are electrically connected to each other.

The external electrode is then formed (step S22). Ni plating and Sn plating are applied to Cu layer 10 in this order to form Ni plated layer 20 and Sn plated layer 30, and thus first external electrode 120 and second external electrode 130 are formed.

Through a series of steps described above, the multilayer ceramic capacitor according to the modification can be manufactured.

In the description of the embodiment above, features that can be combined may be combined.

It should be understood that the embodiment disclosed herein is illustrative and non-restrictive in every respect. The scope of the present invention is defined by the terms of the claims rather than the description above and is intended to include any modifications within the scope and meaning equivalent to the terms of the claims.

### REFERENCE SIGNS LIST

10 Cu layer; 11 Cu component; 12 glass component; 20 Ni plated layer; 30 Sn plated layer; 40 underlying electrode layer; 100 multilayer ceramic capacitor; 101 multilayer body; 101a, 101b main surface; 101c, 101d side surface; 101e, 101f end surface; 110 element body portion; 111 first main surface; 112 second main surface; 113 first side surface; 114 second side surface; 115 first end surface; 116 second end surface; 120 first external electrode; 120E, 130E extension portion; 130 second external electrode; 140 dielectric layer; 150 internal electrode layer; 151 first internal electrode layer; 151C first opposed portion; 151N, 152N narrow-width portion; 151X first drawn portion; 152 second internal electrode layer; 152C second opposed portion; 152X second drawn portion; 160 coating layer; C inner layer portion; E1 first end margin portion; E2 second end margin portion; S1 first side margin portion; S2 second side margin portion; X1 first outer layer portion; X2 second outer layer portion; Xa outermost layer portion; Xb inner-side outer layer portion.

1. A multilayer ceramic capacitor comprising:
an element body portion including a plurality of dielectric layers and a plurality of internal electrode layers that are layered in a layering direction, the element body portion being provided with a first main surface and a second main surface opposed to each other in the layering direction, a first side surface and a second side surface opposed to each other in a width direction orthogonal to the layering direction, and a first end surface and a second end surface opposed to each other in a length direction orthogonal to the layering direction and the width direction; and
an external electrode provided on each of the first end surface and the second end surface, the external electrode being electrically connected to the plurality of internal electrode layers, wherein
the element body portion is provided with a coating layer containing Si, and
a first minimum thickness of the coating layer located at the first and second side surfaces in the width direction is larger than a second minimum thickness of the coating layer located between the plurality of dielectric layers and the external electrode at the first and second end surfaces.

2. The multilayer ceramic capacitor according to claim 1, wherein
a concentration of Si in the coating layer located on the ends of the plurality of internal electrode layers in the width direction is higher than a concentration of Si in the coating layer located between the plurality of dielectric layers and the external electrode.

3. The multilayer ceramic capacitor according to claim 1, wherein
the coating layer further contains K.

4. The multilayer ceramic capacitor according to claim 3, wherein
a concentration of K in the coating layer located on the ends of the plurality of internal electrode layers in the width direction is higher than a concentration of K in the coating layer located between the plurality of dielectric layers and the external electrode.

5. The multilayer ceramic capacitor according to claim 1, wherein the coating layer is amorphous.

6. The multilayer ceramic capacitor according to claim 1, wherein the external electrode includes a first conductive layer containing a glass component, and wherein a portion of the first conductive layer penetrates the coating layer to electrically connect to the plurality of internal electrode layers.

7. The multilayer ceramic capacitor according to claim 6, wherein the external electrode further includes:
a second conductive layer on the first conductive layer; and
a third conductive layer on the second conductive layer.

8. The multilayer ceramic capacitor according to claim 1, wherein the plurality of internal electrode layers include:
a plurality of first internal electrode layers drawn toward the first end surface; and
a plurality of second internal electrode layers drawn toward the second end surface,
wherein each of the first internal electrode layers includes a first narrow-width portion at an end distal to the first end surface, the first narrow-width portion having a width in the width direction that is less than a width of a central portion of the first internal electrode layer, and
wherein each of the second internal electrode layers includes a second narrow-width portion at an end distal to the first end surface, the second narrow-width portion having a width in the width direction that is less than a width of a central portion of the second internal electrode layer.

9. The multilayer ceramic capacitor according to claim 8, wherein
the external electrode on the first end surface includes a first extension portion extending along the first and second side surfaces that overlaps only the second narrow-width portions of the second internal electrode layers when viewed in the width direction, and
the external electrode on the second end surface includes a second extension portion extending along the first and second side surfaces that overlaps only the first narrow-width portions of the first internal electrode layers when viewed in the width direction.

10. The multilayer ceramic capacitor according to claim 1, wherein the minimum thickness of the coating layer located on the ends of the plurality of internal electrode layers in the width direction is between 0.01 μm and 10 μm.

11. The multilayer ceramic capacitor according to claim 1, wherein an outer surface of the element body portion defined by the coating layer has a maximum recess height that is lower than a maximum recess height of a surface of the dielectric layers beneath the coating layer.

12. A multilayer ceramic capacitor comprising:
an element body portion including a plurality of dielectric layers and a plurality of internal electrode layers that are layered in a layering direction, the element body portion being provided with a first end surface and a second end surface;
an underlying electrode layer on each of the first end surface and the second end surface, the underlying electrode layer being electrically connected to the plurality of internal electrode layers;
a coating layer containing Si on the underlying electrode layer; and
an external electrode on the coating layer, wherein a portion of the external electrode penetrates the coating layer to electrically connect to the underlying electrode layer.

13. The multilayer ceramic capacitor according to claim 12, wherein a minimum thickness of the coating layer located on ends of the plurality of internal electrode layers in a width direction is larger than a minimum thickness of the coating layer located between the underlying electrode layer and the external electrode.

14. The multilayer ceramic capacitor according to claim 12, wherein the underlying electrode layer contains Ni.

15. The multilayer ceramic capacitor according to claim 12, wherein the coating layer further contains K, and the external electrode includes a conductive layer containing a glass component.

16. A method of manufacturing a multilayer ceramic capacitor, the method comprising:
forming a multilayer body by layering a plurality of dielectric layers and a plurality of internal electrode layers, the multilayer body having a plurality of side surfaces and a plurality of end surfaces at which the internal electrode layers are exposed;
forming a coating layer containing Si on the side surfaces and the end surfaces of the multilayer body;
applying a conductive paste containing a glass component over the coating layer on the plurality of end surfaces to form an external electrode precursor; and
firing the multilayer body with the external electrode precursor at a temperature sufficient to melt the coating layer on the end surfaces, thereby causing the conductive paste to penetrate the coating layer and electrically connect to the plurality of internal electrode layers,
wherein the coating layer formed on the side surfaces remains thicker than the coating layer on the end surfaces after firing.

17. The method according to claim 16, wherein forming the coating layer includes immersing the multilayer body in a water glass solution containing K.

18. The method according to claim 16, wherein firing is performed at a temperature between 600° C. and 800° C.

19. The method according to claim 16, further comprising, before forming the coating layer:
applying an underlying electrode paste on the plurality of end surfaces; and
firing the multilayer body with the underlying electrode paste to form an underlying electrode layer,
wherein the coating layer is formed on the underlying electrode layer, and the conductive paste electrically connects to the underlying electrode layer.
